(19) United States
(12) Patent Application Publication
(10) Pub. No.: US 2008/0283371 A1
(43) Pub. Date: Nov. 20, 2008

(54) ATV switch actuator and housing design

(76) Inventors: Mark D. Reed, Springfield, IL (US); Al B. Cable, Springfield, IL (US)

Correspondence Address: Bryan Anderson;Patent Services, Honeywell International Inc., 101 Columbia Road, Morristown, NJ, 07962, US

(21) Appl. No.: 11/804,023

(22) Filed: May 16, 2007

(51) Int. Cl. H01H 9/00

(52) U.S. Cl. 200/61.54

(57) ABSTRACT

A switch activator device for ATVs and like vehicles operating in robust environments having a switch housing including an open back side and a front side having a central opening and at least one slots for receiving a switch actuator. At least one switch activator is mounted in the housing with a flange sized to engage the at least one slot in the housing. A central housing insert is put in the housing between the at least one activator to substantially close off the front side of the housing and provide mounting support to maintain the at least one actuator flange in the slot. Preferably the housing, actuators and insert are made by injection molding plastic.

### FIELD OF THE INVENTION

The present invention relates to a switch housing for ATV machines and others having similar controls. More particularly, the invention relates to a switch housing for accommodating the switch actuator geometry for single piece switch actuator designs wherein the opening is closed by inserting a mechanically attached housing insert.

### BACKGROUND OF THE INVENTION

The operation of an ATV requires that the user make multiple switches to control the vehicle. Multiple assemblies are needed to allow for a switch actuator in switch housings when the switch housing actuator is larger than the opening that the actuator arm of the actuator moves in.

It is desirable to minimize the number of components and it is necessary to have a robust construction for ATV use due to the vigorous use these machines encounter.

It would be of advantage in the art if a simple, effective housing for ATV switch actuators could be provided that would be rugged and easy to assemble.

Yet another advantage would be if the housing would permit a switch actuator geometry allowing for a single piece switch actuator design.

Other advantages will appear hereinafter.

### SUMMARY OF THE INVENTION

It has now been discovered that the above and other advantages of the present invention may be obtained in the following manner. Specifically, the present invention provides a switch activator device for ATV and like devices operating in robust environments.

The device has at least three components. A switch housing having means for mounting on a vehicle is provided which locates the housing with respect to other components and wiring to enable the switches to function as intended. The housing has an open back side large enough to insert at least one switch actuator. The front side has central opening with slots for the number of switch actuators and is shaped to engage a switch actuator.

At least one switch activator is mounted in the housing. Each activator has the usual forward extending switch. Each actuator also includes a flange sized to engage one of the slots in the housing, and thus can be larger than the open space. Also provided is a central housing insert which fits in the housing between the activators The insert is sized to substantially close off the remaining part of the front side of the housing and supportively hold the actuator in place with their respective flanges in the slots.

In a preferred embodiment, the housing, actuator or actuators and insert are formed by injection molding plastic. Other materials such as metal can be used. Also preferred is that the back of the actuator or actuators and the insert are sized to completely close off the back opening in the housing after the parts have been inserted into the housing.

### BRIEF DESCRIPTION OF THE DRAWINGS

For a more complete understanding of the invention, reference is hereby made to the drawings, wherein like numbers refer to like elements, and in which:

FIG. 1 is a perspective view of the present invention; and

FIG. 2 is an exploded view, also in perspective, of the device in FIG. 1 prior to assembly.

### DETAILED DESCRIPTION OF THE PREFERRED EMBODIMENT

The present invention provides for substantial improvements in housing for ATVs and other rough terrain engaging vehicles. In its simplest form, the present invention incorporates an opening in the switch housing that allows for pass-through of the switch actuator geometry, allowing for a single piece switch actuator design rather than prior art designs where multipart assemblies are needed to allow for a switch actuator when the switch actuator is larger than the opening in which the actuator arm of the actuator moves. While the invention is suitable for one or more than one switch actuator, and may include four or six actuators as desired, the preferred embodiment shown in the drawings uses two switch actuators for illustration and not by way of limitation.

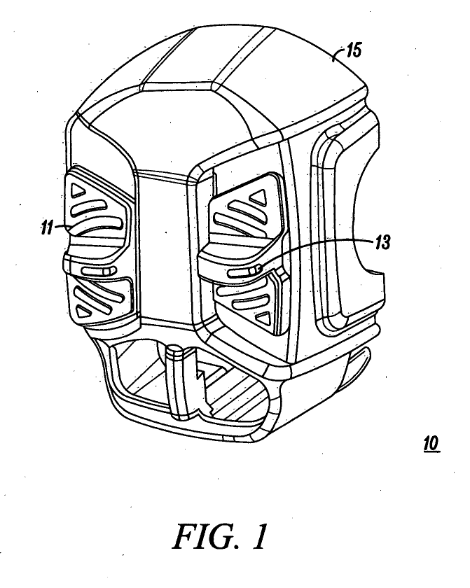

The fully assembled housing with switches is shown generally in FIG. 1 by reference 10. Switches 11 and 13 are fully operable.

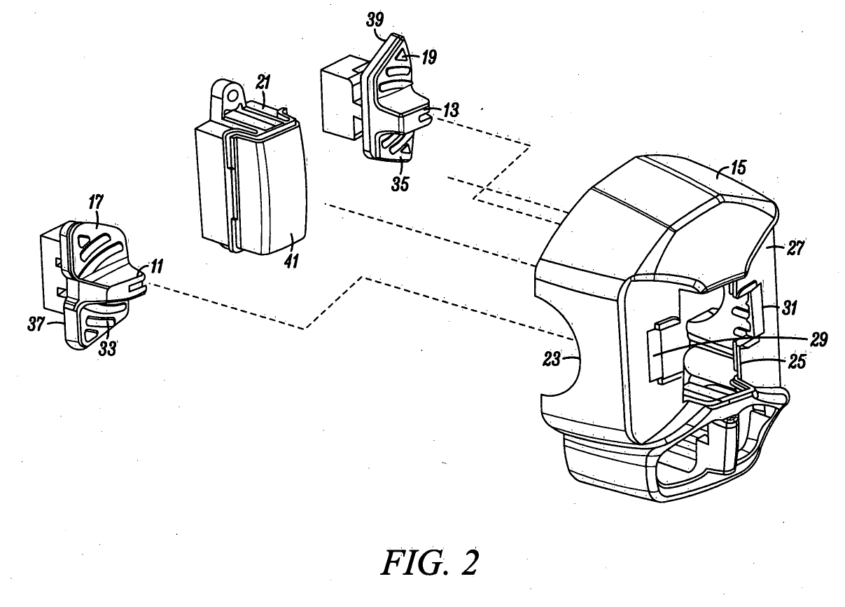

In FIG. 2, device 10 is shown in an exploded view with housing 15, first switch actuator assembly 17, second switch actuator assembly 19 and insert 21. Housing 15 includes an open back side 23 and an opening 25 in the front 27 of housing 15.

Opening 25 includes a first slot 29 and a second slot 31, each disposed to the side of opening 25. Actuators 17 and 19 each have a full face, 33 and 35 respectively, which form the face of the assembly as seen in FIG. 1. The back portion of faces 33 and 35 have a flange 37 and 39 respectively that fits in slots 29 and 31 respectively. In assembly, first one switch actuator assembly 17 and then the other one 19 are inserted in the back 23 of housing 15 and extended through opening 25 and slid sideways so that flanges 37 and 39 engage slots 29 and 31.

Once the assemblies 17 and 19 are in place, an insert 21 is inserted into the back 23 of housing 15 until insert 21 engages the switch actuator assemblies 17 and 19, and also until the front 41 of insert 21 completes closure of hole 25, as seen in FIG. 1. As can be seen in FIG. 2, the backs of switch actuator assemblies 17 and 19 and the back of insert 21 are sized to close off opening 23 in housing 15. The device is ready to be used with an ATV or other similar vehicle.

While particular embodiments of the present invention have been illustrated and described, it is not intended to limit the invention, except as defined by the following claims.

1. A switch activator device for ATV and like devices operating in robust environments, comprising:
a switch housing having means for mounting on a vehicle, said housing including an open back side and a front side having a central opening and at least one slot for receiving a switch activator;
at least one switch activator for mounting in said housing, each activator having a forward extending switch and a flange sized to engage one of said slots in said housing; and
a central housing insert for mounting in said housing proximate said at least one activator, said insert being sized to substantially close off the front side of said housing and provide mounting support to maintain said actuator flange in said slot.

2. The device of claim 1, wherein at least one switch activator and said central housing insert close off said back side of said housing.

3. The device of claim 1, wherein said housing, and said insert are formed from plastic.

4. The device of claim 3, wherein said plastic is injection molded plastic.

5. The device of claim 1, wherein said insert is fixedly mounted in said housing.

6. A switch activator device for ATV and like devices operating in robust environments, comprising:
switch housing means for mounting switch activator on a vehicle, said housing means including an open back side and a front side having a central opening and at least one slot means for receiving a switch actuator;
at least one switch activator means for mounting in said housing and functioning as a switch, said at least one activator means having a forward extending switch and a flange means for engaging said at least one slot in said housing means; and
a central housing insert means for mounting in said housing means between said at least one activator means, said insert means being sized to substantially close off the front side of said housing and provide mounting support to maintain said at least one actuator flange means in said slots means.

7. The device of claim 6, wherein said at least one switch activator means and said central housing insert means close off said back side of said housing means.

8. The device of claim 6, wherein said housing means and said insert means are formed from plastic.

9. The device of claim 8, wherein said plastic is injection molded plastic.

10. The device of claim 6, wherein said insert means is fixedly mounted in said housing means.

11. A method of forming a switch activator device for ATV and like devices operating in robust environments, comprising the steps of:
providing a switch housing having means for mounting on a vehicle, said housing including an open back side and a front side having a central opening and at least one slot for each receiving a switch activator;
inserting said at least one switch activator in said housing, each activator having a forward extending switch and a flange sized to engage said at least one slot in said housing, whereby each flange engages one slot in said housing; and
inserting a central housing insert in said housing between said at least one activator, said insert being sized to substantially close off the front side of said housing and provide mounting support to maintain said at least one actuator flange in said slot.

12. The method of claim 11, wherein said at least one switch activator and said central housing insert are positioned to close off said back side of said housing.

13. The method of claim 11, wherein said housing and said insert are formed from plastic.

14. The method of claim 13, wherein said plastic is injection molded plastic.

15. The device of claim 11, wherein said insert is fixedly mounted in said housing.
